(19) United States
(12) Patent Application Publication
(10) Pub. No.: US 2019/0180623 A1
(43) Pub. Date: Jun. 13, 2019

(54) COLLISION PREDICTION METHOD AND DEVICE

(71) Applicant: AUTOMOTIVE RESEARCH & TESTING CENTER, Changhua County (TW)

(72) Inventors: CHAO-YANG LEE, CHANGHUA COUNTY (TW); YOU-WEI LIN, CHANGHUA COUNTY (TW)

(21) Appl. No.: 15/840,201

(22) Filed: Dec. 13, 2017

(51) Int. Cl. G08G 1/16; B60T 7/22; B60Q 9/00

(52) U.S. Cl. CPC G08G 1/166; B60T 7/22; B60T 2210/36; B60T 2201/022; B60Q 9/008

(57) ABSTRACT

The present invention discloses a collision prediction method and device. The device comprises a communication device and a central processor, which are installed in a first vehicle. The communication device receives vehicular information of a second vehicle and transmits the vehicular information to the central processor. According to the position, speed, direction and dimensions of the second vehicle, the central processor generates a vehicular region with a collision point being the center. The vehicular region spans double a length of the dimensions of the second vehicle along the direction of the second vehicle. The central processor moves the vehicular region by a GPS offset to generate a movement range and generates a collision area according to the movement range. The present invention uses the collision point, the dimensions of the second vehicle and the spatial error to estimate the collision area to effectively increase the accuracy of predicting collision.

### BACKGROUND OF THE INVENTION

### Field of the Invention

The present invention relates to a collision estimation technology, particularly to a collision prediction method and a device thereof.

### Description of the Related Art

Being a transporter, the vehicle has played an important and indispensable role in daily living. Although vehicles are efficient and convenient in traffic, they also have defects. Vehicles running fast may collide with each other and bring about serious traffic accidents. Traffic accidents may be caused by natural factors or human factors. However, most traffic accidents are caused by human factors. Therefore, controlling the human factors can prevent a running vehicle from colliding with another vehicle or pedestrians and decrease the number of traffic accidents effectively.

Thus, the devices able to detect the barrier before a vehicle, measure the distance between the barrier and the vehicle, and warn the driver of the barrier have been developed successively. The detection devices most frequently used to predict the front barrier are the distance sensor (such as a radar) or the image sensor. The distance sensor is used to detect a barrier in a single direction. The image sensor can be used to detect barriers in a wide angle. The abovementioned sensors can assist the driver in grasping the status of the vehicle and the distance between the barrier and the vehicle. The abovementioned sensors can cooperate with an alert system to avoid collision.

In addition to the abovementioned distance sensor and image sensor, the global positioning system (GPS) can also be used to detect the distance between the vehicle and the barrier. However, some factors may hinder GPS from detecting barriers, such as the weather or shelters. Thus, the application thereof is limited.

No matter whether the distance sensor, the image sensor or the GPS system is used, the acquired distance between the vehicle and the barrier can only be used to calculate the collision point of the vehicle and the barrier. However, instable signals may result in errors of the acquired distance. Further, the range of the collision point is very small. Thus, the output collision point is likely to deviate. Therefore, the position of the collision point has high uncertainty.

Accordingly, the present invention proposes a collision prediction method and a device thereof to overcome the abovementioned problems.

### SUMMARY OF THE INVENTION

The primary objective of the present invention is to provide a collision prediction method and device, which can estimate the collision point of a first vehicle and a second vehicle and uses the collision point, the dimensions of the second vehicle, and the spatial error to predict the collision area, whereby to effectively increase the accuracy of predicting the collision area.

Another objective of the present invention is provide a collision prediction method and device, which can give the driver an alert, decelerate the vehicle or brake the vehicle according to the degree of risk, whereby to enhance driving safety.

In order to achieve the abovementioned objectives, the present invention proposes a collision prediction method, which comprises steps: a first vehicle receiving vehicular information of at least one second vehicle, wherein the vehicular information includes position, speed, direction and dimensions of the second vehicle; the first vehicle calculating a collision point of the first vehicle and the second vehicle according to the position, speed and direction of the second vehicle; the first vehicle generating a vehicular region with the collision point being a center, wherein the vehicular region spans double the length of the dimensions of the second vehicle along the direction of the second vehicle; and the first vehicle acquiring a global positioning system (GPS) offset, moving the vehicular region by the GPS offset to generate a movement range, and generating a collision area according to the movement range.

The present invention also proposes a collision prediction device, which is installed in a first vehicle and able to predict the probable collision area, and which comprises a communication device and a central processor. The communication device receives a GPS offset of the first vehicle and vehicular information of at least one second vehicle, wherein the vehicular information includes position, speed, direction and dimensions of the second vehicle. The central processor is electrically connected with the communication device to receive the vehicular information of the second vehicle. The central processor calculates a collision point of the first vehicle and the second vehicle according to the position, the speed and the direction. The central processor generates a vehicular region with the collision point being the center. The vehicular region spans double the length of the dimensions of the second vehicle along the direction of the second vehicle. The central processor acquires a global positioning system (GPS) offset through the communication device. The central processor moves the vehicular region by the GPS offset to generate a movement range and generates a collision area according to the movement range.

Below, embodiments are described in detail to make easily understood the objectives, technical contents, characteristics and accomplishments of the present invention.

### BRIEF DESCRIPTION OF THE DRAWINGS

FIG. 1 is a block diagram schematically showing a collision prediction device according to one embodiment of the present invention;

FIG. 2 is a flowchart of a collision prediction method according to one embodiment of the present invention;

FIG. 3 is a diagram schematically showing a collision point according to one embodiment of the present invention;

FIG. 4 is a diagram schematically showing how to determine a collision point according to one embodiment of the present invention;

FIG. 5 is a diagram schematically showing how to generate a vehicular region according to one embodiment of the present invention;

FIG. 6 is a diagram schematically showing how to generate a movement range according to one embodiment of the present invention;

FIG. 7 is a diagram schematically showing how to generate a collision area according to one embodiment of the present invention; and

FIG. 8 is a flowchart of an alert mechanism according to one embodiment of the present invention.

### DETAILED DESCRIPTION OF THE INVENTION

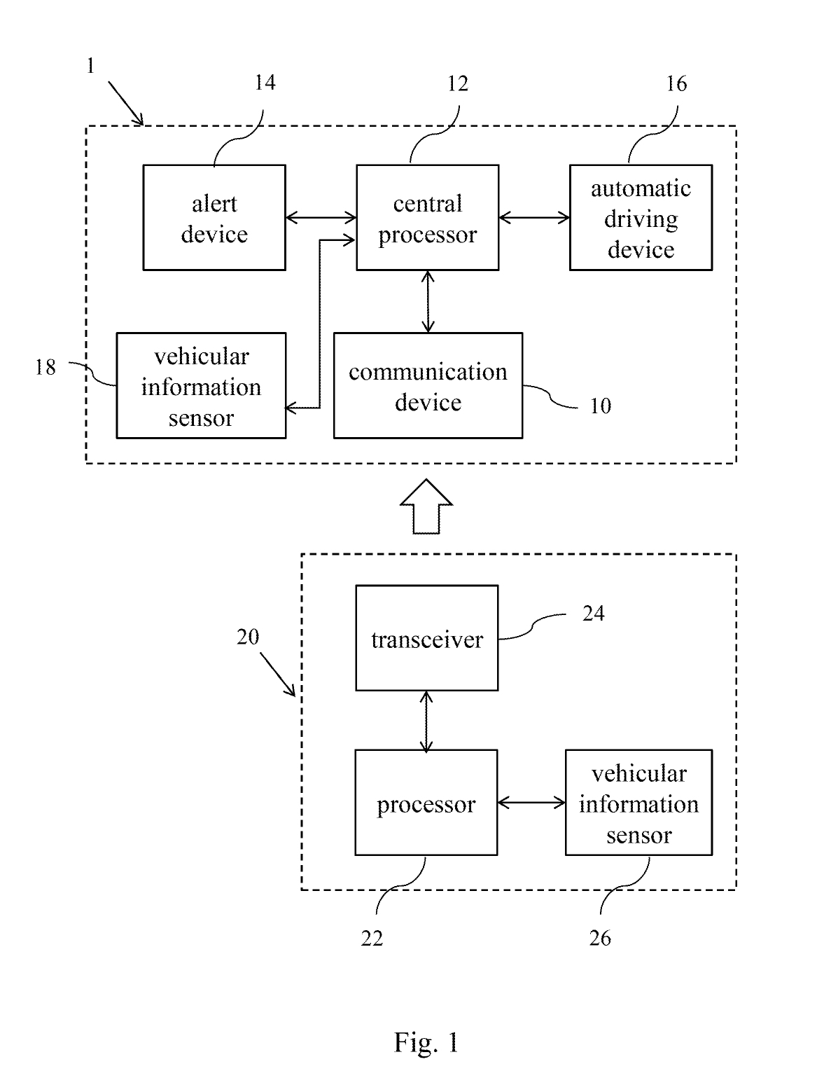

Refer to FIG. 1 a block diagram schematically showing the system of a collision prediction device according to one embodiment of the present invention. The collision prediction device 1 of the present invention is installed in a first vehicle to predict the probable range of the collision between the first vehicle and a second vehicle. The collision prediction device 1 of the present invention comprises a communication device 10 and a central processor 12. The communication device 12 may be a wireless communication device or an Internet communication device, which can persistently receive external information from other vehicles, including the positions, speeds, directions and dimensions of other vehicles. The communication device 10 includes a GPS (Global Positioning System) receiver (not shown in the drawing) to receive GPS information and acquire the position GPS offset of the first vehicle. The central processor 12 is electrically connected with the communication device 10 to acquire the information received by the communication device 10. The central processor 12 is also electrically connected with a vehicular information sensor 18. The vehicular information sensor 18 includes a direction sensor (not shown in the drawing), a speed sensor (not shown in the drawing), etc. The central processor 12 receives the vehicular information sensed by the vehicular information sensor 18, such as the direction, speed, etc. of the first vehicle. Thereby, the central processor 12 can predict the area of collision between the first vehicle and the second vehicle, using vehicular information, such the position, direction, speed, etc. of the first vehicle, and the vehicular information of the second, which is received by the communication device 10. The central processor 12 can further use the area of collision to predict the time of collision and then sends out an alert or undertake other treatments. The alert device 14 is electrically connected with the central processor 12 and controlled to send out an alert by the central processor 12. The automatic driving device 16 is electrically connected with the central processor 12 and controlled by the central processor 12 to undertake deceleration or braking.

Refer to FIG. 1 again. The communication device 10 receives the vehicular information of the second vehicle from a vehicular computer system 20 installed in the second vehicle. The vehicular computer system 20 comprises a processor 22, a transceiver 24, and a vehicular information sensor 26. The processor 22 records the dimensions of the second vehicle and is electronically connected with the transceiver 24. The transceiver 24 may be an Internet transceiver. The processor 22 controls the transceiver 24 to transmit information to the communication device 10. The transceiver 24 includes a GPS receiver (not shown in the drawing) to receive GPS signals and transfer the GPS signals to the processor 22. Thus, the processor 22 acquires the current position of the second vehicle. The processor 22 is also electrically connected with the vehicular information sensor 26. The vehicular information sensor 26 includes a direction sensor (not shown in the drawing) and a speed sensor (not shown in the drawing). The processor 22 controls the vehicular information sensor 26 to sense the direction and speed and acquires vehicular information of the second vehicle, such as the dimensions, speed, direction and position of the second vehicle. The processor 22 uses the transceiver 24 to transmit the acquired vehicular information to the collision prediction device 1.

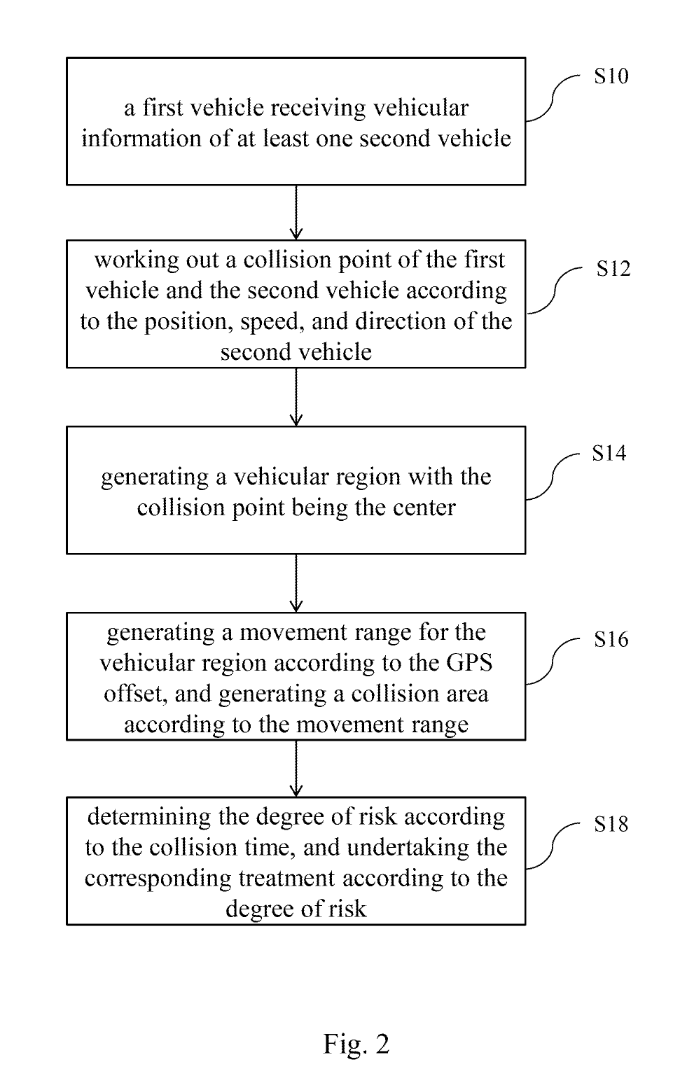

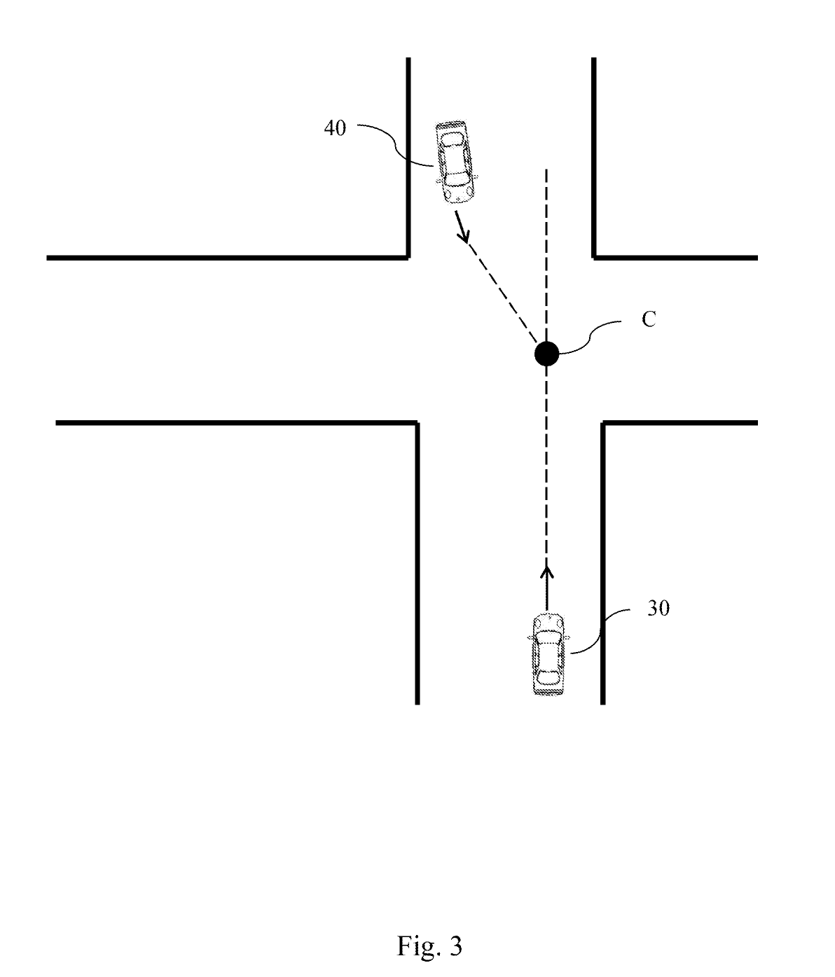

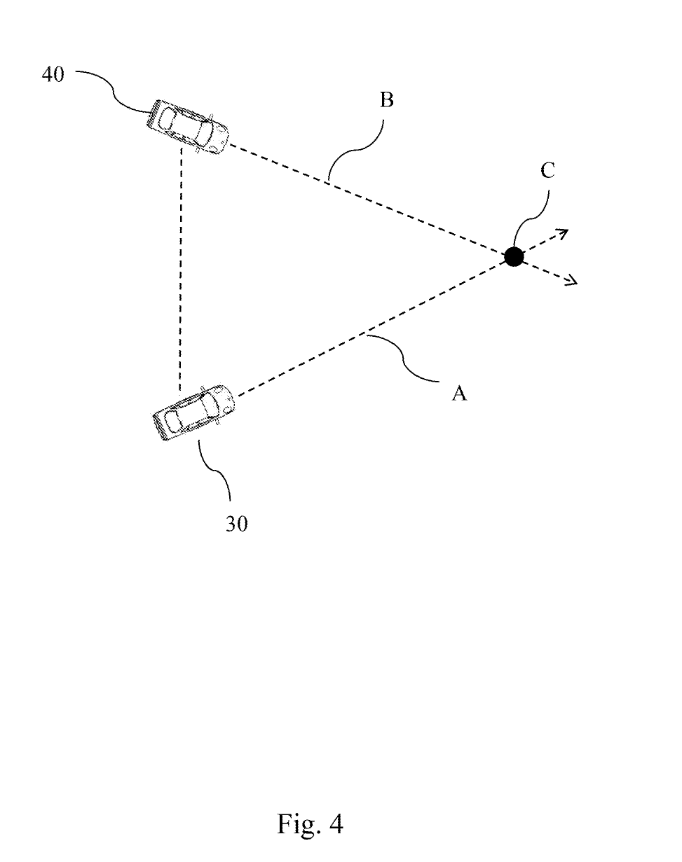

After the structure of the system, which the method of the present invention applies to, has been described above, the method of the present invention will be described below. Refer to FIG. 1 and FIGS. 2-7. In this embodiment, the method of the present invention is used to predict the probable area of collision for vehicles heading for different directions in an intersection of roads. In Step S10, the collision prediction device 1 is installed a first vehicle 30 and uses the communication device 10 to receive the vehicular information transmitted by the vehicular computer systems 20 of a second vehicle 40, which is heading for a direction different from that of the first vehicle 30 in the intersection of roads. The vehicular information includes the position, speed, direction and dimensions of the second vehicle 40. Next, the process proceeds to Step S12. Refer to FIG. 3. The central processor 12 of the first vehicle 30 works out a collision point C of the first vehicle 30 and the second vehicle 40 using the positions, speeds, and directions of the first vehicle 30 and the second vehicle 40. In the method of calculating the collision point of the first vehicle 30 and the second vehicle 40, transform the positions of the first vehicle 30 and the second vehicle 40 into planar coordinates firstly. Next, extend a straight line A along the direction of the first vehicle 30 from the positional coordinates of the first vehicle 30, and extend a straight line B along the direction of the second vehicle 40 from the positional coordinates of the second vehicle 40, as shown in FIG. 4. The straight line A and the straight line B intersect at an intersection point to form a triangle, and the intersection point is exactly the collision point C. Next, work out the distance between the first vehicle 30 and the second vehicle 40 using the positional coordinates of the first vehicle 30 and the second vehicle 40, which have been acquired beforehand. As the collision point C, the first vehicle 30, and the second vehicle 40 form a triangle, the interior angle of the collision point C can be worked out according to trigonometry. The distance between the first vehicle 30 and the second vehicle 40 can be used to work out the distance between the first vehicle 30 and the collision area (BDM) according to the sine law.

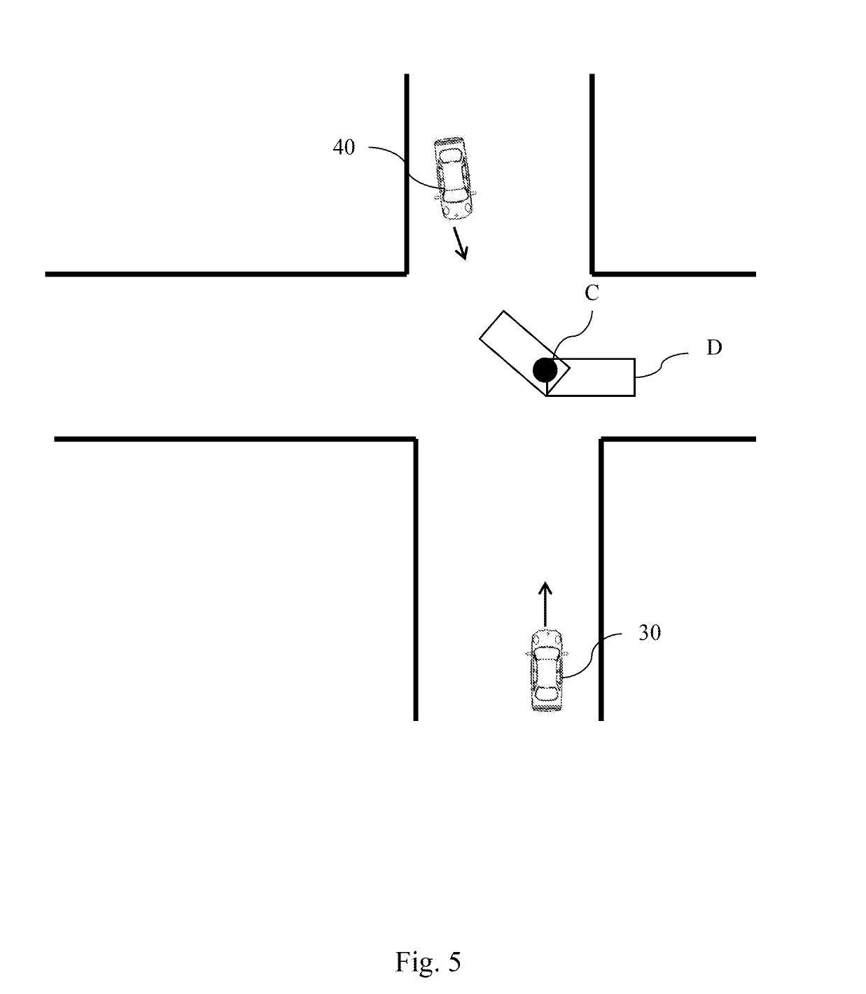

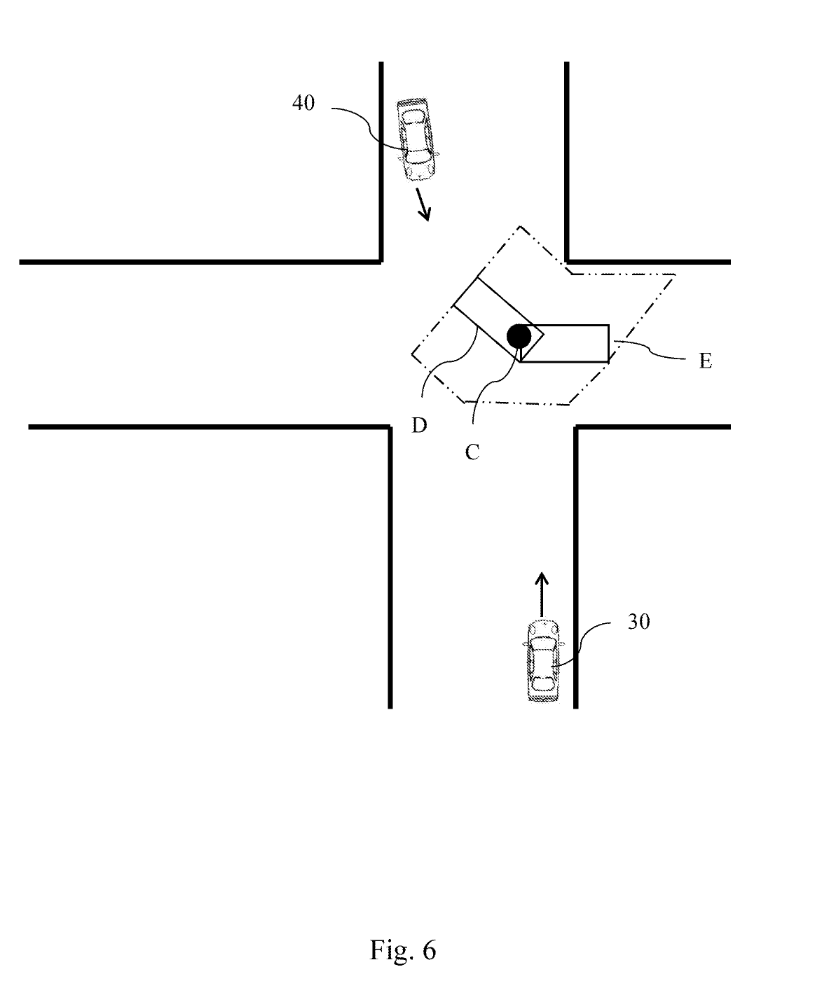

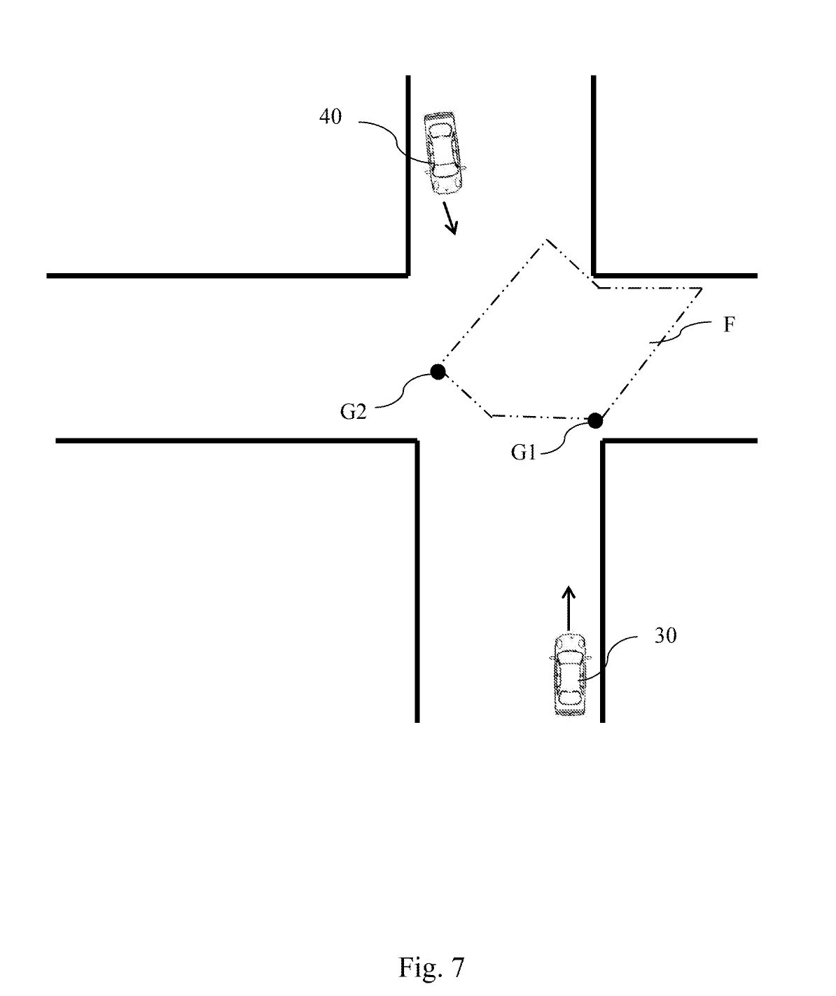

After the collision point C is worked out, the process proceeds to Step S14. Refer to FIG. 5. In Step S14, the central processor 12 of the first vehicle 30 creates a vehicular region D with the collision point C being the center. The vehicular region D spans double the length of the dimensions of the second vehicle 40 along the direction of the second vehicle 40. Next, the process proceeds to Step S16. Refer to FIG. 6. The central processor 12 generates a movement range E for the vehicular region D according to the GPS offset received by the communication device 10. Refer to FIG. 7. Next, the central processor 12 generates a collision area F according to the movement range E.

After the collision area F is worked out, the process proceeds to Step S18. The central processor 12 estimates the time of collision between the first vehicle 30 and the collision area F, determines the degree of risk according to the time of collision, and undertakes the corresponding treatment according to the degree of risk.

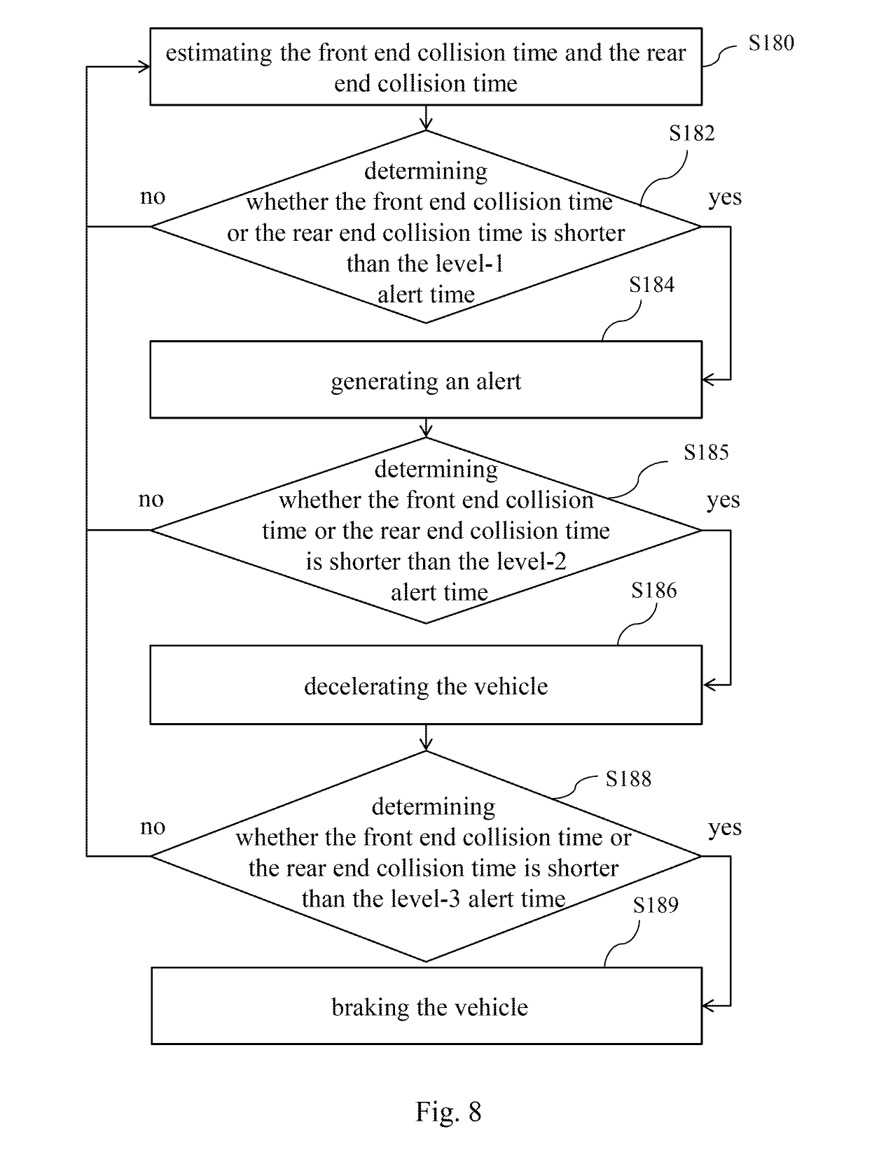

In detail, the closer the vehicle to the collision area, the shorter the collision time (the time interval between now and collision). In this embodiment, the level-1 alert time (the collision time of the level-1 alert) is set to be longer than the level-2 alert time (the collision time of the level-2 alert), and the level-2 alert time is set to be longer than the level-3 alert time (the collision time of the level-3 alert). Then, the level-1, level-2, level-3 alert times are respectively corresponding to the risks from a low degree to a high degree. Refer to FIG. 7 and FIG. 8. The process of determining the degree of risk and the corresponding treatment includes Steps S180-189. In Step S180, estimate how much time later the collisions will take place between the first vehicle 30 and the front end G1 and the rear end G2 of the collision area F, which face the first vehicle 30, to generate a front end collision time and a rear end collision time. The front end collision time and the rear end collision time are calculated according to a collision time equation:

$${t}_{BDM} = \frac{BDM}{{V}_{B}} \pm \frac{ERROR}{{V}_{B}}$$

wherein t_{BDM} is the front end collision time or the rear end collision time; V_{B} is the speed of the first vehicle; BDM is the distance between the first vehicle and the front end or rear end of the collision area.

After the front end or rear end collision time is acquired, the process proceeds to Step S182. In Step S182, the central processor 12 determines whether one of the front end collision time and the rear end collision time is shorter than the level-1 alert time. If no, the process returns to Step S180 and continues to estimate the front end collision time and the rear end collision time. If yes, the process proceeds to Step S184. In Step S184, the central processor 12 controls the alert device 14 to generate an alert to remind the driver. In one embodiment, the alert device 14 is a display device presenting an alert image to remind the driver of the probable collision. In one embodiment, the alert device is an audio device generating an alert sound to remind the driver.

After the alert signal is sent out, the process proceeds to Step S185. In Step S185, the central processor 12 determines whether one of the front end collision time and the rear end collision time is shorter than the level-2 alert time. If no, the process returns to Step S180 and continues to estimate the front end collision time and the rear end collision time. If yes, it indicates that the first vehicle 30 becomes more close to the collision area F, and the process proceeds to Step S186. In Step S186, the central processor 12 sends a deceleration signal to the automatic driving device 16, and the automatic driving device 16 undertakes deceleration according to the deceleration signal. Next, the process proceeds to Step S188. In Step S188, the central processor 12 determines whether one of the front end collision time and the rear end collision time is shorter than the level-3 alert time. If no, the process returns to Step S180 and continues to estimate the front end collision time and the rear end collision time. If yes, it indicates that the first vehicle 30 becomes further more close to the collision area F, and the process proceeds to Step S189. In Step S189, the central processor 12 sends a braking signal to the automatic driving device 16 to directly brake the first vehicle 30. According to the abovementioned classification of risks, the present invention reminds the driver of probable collision while the vehicle 30 is approaching the collision area F firstly; if the driver does not decelerate the first vehicle 30 but let the first vehicle 30 further approach the collision area F, the present invention controls the automatic driving device 16 to decelerate or brake the first vehicle 30. Therefore, the present invention can effectively prevent collision and enhance driving safety.

In conclusion, the present invention can estimate the collision points of this vehicle and another vehicle, and estimate the collision area according to the collision points, the dimensions of another vehicle, and spatial error. Therefore, the present invention can increase the accuracy of predicting the collision area. Further, the present invention can give the driver an alert, decelerate the vehicle, or brake the vehicle according to the degree of risk. Therefore, the present invention can effectively enhance driving safety.

The embodiments described above are only to exemplify the present invention but not to limit the scope of the present invention. Any equivalent modification or variation according to the characteristic or spirit of the present invention is also to be included by the scope of the present invention.

What is claimed is:

1. A collision prediction method comprising steps:
a first vehicle receiving vehicular information of at least one second vehicle, wherein said vehicular information includes position, speed, direction and dimensions of said second vehicle;
said first vehicle calculating a collision point of said first vehicle and said second vehicle according to said position, said speed and said direction of said second vehicle;
said first vehicle generating a vehicular region with said collision point being a center, wherein said vehicular region spans double a length of said dimensions of said second vehicle along said direction of said second vehicle; and
said first vehicle acquiring a global positioning system (GPS) offset, moving said vehicular region by said GPS offset to generate a movement range, and generating a collision area according to said movement range.

2. The collision prediction method according to claim 1, wherein said step of calculating said collision point of said first vehicle and said second vehicle includes steps:
transforming a position of said first vehicle and said position of said second vehicle into planar coordinates; and
extending a first straight line from said coordinates of said first vehicle along a direction of said first vehicle, extending a second straight line along said direction of said second vehicle, and letting said first straight line and said second straight line intersect to form an intersection point, wherein said intersection point is said collision point, and wherein said position of said first vehicle, said position of said second vehicle, and said intersection point form a triangle.

3. The collision prediction method according to claim 1 further comprising steps:
estimating collision times after which said first vehicle will collide with a front end and a rear end of said collision area, which face said first vehicle, to generate a front end collision time and a rear end collision time; and
while said front end collision time or said rear end collision time is shorter than a level-1 alert time, generating an alert signal to remind a driver.

4. The collision prediction method according to claim 3, wherein while said front end collision time or said rear end collision time is shorter than a level-2 alert time, generating a deceleration signal to control said first vehicle to decelerate.

5. The collision prediction method according to claim 4, wherein while said front end collision time or said rear end collision time is shorter than a level-3 alert time, generating a braking signal to control said first vehicle to brake.

6. The collision prediction method according to claim 5, wherein said front end collision time and said rear end collision time are calculated according to an equation:
$${t}_{BDM} = \frac{BDM}{{V}_{B}} \pm \frac{ERROR}{{V}_{B}}$$
wherein t_{BDM} is said front end collision time or said rear end collision time; V_{B} is a speed of said first vehicle; BDM is a distance between said first vehicle and said front end or said rear end of said collision area.

7. A collision prediction device, which is installed in a first vehicle, comprising
a communication device receiving a global positioning system (GPS) offset of said first vehicle and vehicular information of at least one second vehicle, wherein said vehicular information includes position, speed, direction and dimensions of said second vehicle; and
a central processor electrically connected with said communication device to receive said vehicular information of said second vehicle; calculating a collision point of said first vehicle and said second vehicle according to said position, said speed and said direction, generating a vehicular region with said collision point being a center, wherein said vehicular region spans double a length of said dimensions of said second vehicle along said direction of said second vehicle; acquiring said global positioning system (GPS) offset through said communication device; moving said vehicular region by said GPS offset to generate a movement range; and generating a collision area according to said movement range.

8. The collision prediction device according to claim 7, wherein a process of said central processor calculating said collision point of said first vehicle and said second vehicle includes steps:
transforming a position of said first vehicle and said position of said second vehicle into planar coordinates; and
extending a first straight line from said coordinates of said first vehicle along a direction of said first vehicle, extending a second straight line along said direction of said second vehicle, and letting said first straight line and said second straight line intersect to form an intersection point, wherein said intersection point is said collision point, and wherein said position of said first vehicle, said position of said second vehicle, and said intersection point form a triangle.

9. The collision prediction device according to claim 8, wherein said central processor is electrically connected with an alert device, and wherein said central processor estimates collision times after which said first vehicle will collide with a front end and a rear end of said collision area, which face said first vehicle, to generate a front end collision time and a rear end collision time; while said front end collision time or said rear end collision time is shorter than a level-1 alert time (said collision time of a level-1 alert), said central processor generates an alert signal to control said alert device to send out an alert to remind a driver.

10. The collision prediction device according to claim 9, wherein said central processor is electrically connected with an automatic driving device, and wherein while said central processor determines that said front end collision time or said rear end collision time is shorter than a level-2 alert time, said central processor generates a deceleration signal to control said automatic driving device to decelerate said first vehicle.

11. The collision prediction device according to claim 10, wherein while said central processor determines that said front end collision time or said rear end collision time is shorter than a level-3 alert time, said central processor generates a braking signal to control said automatic driving device to brake said first vehicle.

12. The collision prediction device according to claim 11, wherein said central processor calculates said front end collision time and said rear end collision time according to an equation:
$${t}_{BDM} = \frac{BDM}{{V}_{B}} \pm \frac{ERROR}{{V}_{B}}$$
wherein t_{BDM} is said front end collision time or said rear end collision time; V_{B} is a speed of said first vehicle; BDM is a distance between said first vehicle and said front end or said rear end of said collision area.

13. The collision prediction device according to claim 11, wherein said alert device is a display device or an audio device, and wherein said display device presents an alert image to remind a user, and wherein said audio device generates an alert sound to remind a user.

14. The collision prediction device according to claim 7, wherein said vehicular information of said second vehicle is sent out by a vehicular computer system installed in said second vehicle.
